(19) United States
(12) Patent Application Publication
(10) Pub. No.: US 2010/0104918 A1
(43) Pub. Date: Apr. 29, 2010

(54) IMPROVED FUEL CELL PROTON EXCHANGE MEMBRANES

(75) Inventors: Robert M. Nowak, Midland, MI (US); Claire Hartmann-Thompson, Midland, MI (US); Kenneth J. Bruza, Alma, MI (US); Lowell S. Thomas, Midland, MI (US); Dale J. Meier, Midland, MI (US)

Correspondence Address: TECHNOLOGY LAW, PLLC, 3595 N. SUNSET WAY, SANFORD, MI, 48657, US

(73) Assignee: Michigan Molecular Institute, Midland, MI (US)

(21) Appl. No.: 12/450,793

(22) PCT Filed: Apr. 11, 2008
(86) PCT No.: PCT/US2008/004695

§ 371 Date: Oct. 13, 2009

Related U.S. Application Data
(60) Provisional application No. 60/923,297, filed on Apr. 13, 2007.

(51) Int. Cl. H01M 8/10; H01M 6/18

(52) U.S. Cl. 429/33; 429/306

(57) ABSTRACT

This invention concerns an improved PEM for fuel cell applications such that the membrane is more robust. Specifically, this invention provides PEM in MEA systems that have nano-particles carrying proton conducting groups, and improved dimensional stability relative to conductivity. This invention provides a composition of matter for a high proton conductance, solid polymer electrolyte membrane, said membrane comprising: A) a nano-additive carrying proton conducting groups having a size from about 1 nm to about 1,000 run; B) a carrier polymer for the nano-additive of Part A; and C) a proton exchange membrane (PEM) or membrane electrode assembly (MEA) formed by mixing the components of Part A and Part B above. These proton conducting groups are contributed by POSS-based nano-additives or cyclic phosphazene-based nano-additives or small molecules carrying sulfonic acid groups in fuel cells or batteries.

### FEDERALLY SPONSORED RESEARCH STATEMENT

This invention was made with Government support under Award No. DE-FG36-06GO86043, Center for Intelligent Fuel Cell Materials Design, Department of Energy by Michigan Molecular Institute as a subcontractor to Chemsultants International, the award recipient. The Government has certain rights in this invention.

### BACKGROUND OF THE INVENTION

1. Field of the Invention

This invention generally concerns fuel cell proton exchange membranes. Improvements to these membranes have been introduced by this invention for nano-additives that carry proton conducting groups.

2. Description of Related Art

Fuel cells have the potential to become an important energy conversion technology. In order to reduce dependence on oil and avoid its pollution issues, research efforts on fuel cells have increased in recent years. Proton exchange membrane or proton conducting membrane (PEM) fuel cells use a solid polymer electrolyte to separate the fuel from the oxidant. PEM fuel cells are being developed for three commercial areas: automotive, stationary and portable power supply. Requirements for good PEM fuel cell performance include: high proton conductivity; low electron conductivity; ability to function at high temperature (100° C. and above) and good conductivity over a wide humidity range low permeability to fuel and oxidant; good oxidative and hydrolytic stability; good mechanical properties in both dry and hydrated states; low cost; and capability for fabrication into membrane electrode assemblies (MEA). The more of these desired requirements that can be met by the PEM, the better the commercial product.

In the 1960s when polymeric PEMs were first used with hydrogen based systems, such PEM fuel cells were extremely expensive and had a short life for use because of the oxidative degradation of their sulfonated polystyrene-divinylbenzene copolymer membranes. Thus these fuel cells were not commercially viable.

Nearly all present membrane materials for PEM fuel cells rely on absorbed water and its interaction with acid groups to produce conductivity. Due to the large amount of water absorbed in the membrane, both mechanical properties and water transport become key issues. Thus systems that can conduct protons with low or no water are desirable. Methanol fuel cells are desired for portable fuel cell applications, but unreacted methanol at the anode can diffuse through the membrane and react at the cathode (crossover), thus lowering voltage efficiency and therefore the fuel efficiency of the systems.

The only commercially successful membrane at present is Nafion™ that was developed in the 1960s by DuPont. This membrane is a permselective separator in chloralkali electrolyzers [U.S. Pat. No. 4,113,585; S. M. Ibrahim et al., Proc. Electrochem. Soc. 83-86 (1983)]. Nafion is a free radical initiated copolymer of a crystallizable hydrophobic tetrafluoroethylene backbone sequence with a comonomer which has pendant side chains of perfluorinated vinyl ethers terminated by perfluorosulfonic acid groups (see FIG. 5). Details of the synthesis and molecular weight have not been reported. The equivalent weights of Nafion commercially available provide high protonic conductivity and moderate swelling in water, thus making it suitable for many applications. Thinner membranes are used for hydrogen/air application to reduce Ohmic losses; thicker membranes are used for direct methanol fuel cells to reduce methanol crossover. Some of Nafion's drawbacks include: poor temperature performance above 80° C.; low dimensional stability at high water concentrations; degradation in the presence of peroxides; crossover of methanol through the PEM; and high cost.

To overcome some of Nafion's drawbacks, many other linear polymer approaches have been developed (e.g., styrene, styrene-derivatives, poly(arylene ether)s, sulfonation of existing aromatic polymers, co-polymers from sulfonated monomers, poly(imide)s, altered backbone polymers, polyphosphazene [see J. E. McGrath et al., Chem. Rev., 104, 4587-4612 (2004)], but no single material has succeeded in overcoming all the drawbacks. Some approaches have involved the introduction of silica in PEM polymer formulations. Plasma enhanced chemical vapor deposition (PECVD) has been used to deposit nano-scale films of silica (10, 32, 68 nm) on the Nafion film [D. Kim et al., Electrochem. Commun. 6, 1069-1074 (2004)]. Nafion membranes modified with silica and doped with phosphotungstic acid have been tried in order to increase the temperature (i.e., >100° C.) for hydrogen/oxygen PEM use [Zhi-Gang Shao et al., J. of Membrane Sci. 229, 43-51 (2004)]. Ionomeric composites based on organophilized silica and a thermoplastic elastomer have been made to form thin films (i.e., 0.2-0.4 mm) [J. L. Acosta et al., J. Appl. Polym. Sci. 90, 2715-2720 (2003)]. Thermally and chemically robust sulfonic acid PEMs have been made from polysilsesquioxanes [M. Khiterer et al., Chem. Mater. 18, 3665-3673 (2006)]. The resulting membranes have been shown to have the following benefits: higher temperature performance; mechanical reinforcement; lower gas permeability; and improved dimensional stability (reduced swelling). These methods all use conventional (non-functionalized) silicas. In conventional PEMs (either linear polymer, or linear polymer with additional silica), proton-conducting capacity is provided solely by the polymer.

In order to address the shortcomings of conventional homopolymer fuel cell membranes, a number of composite membranes have been studied. Some composite membranes have interpenetrating network structures, e.g., polybenzimidazole (PBI) or polysulfone (PSU) interpenetrated with an ion conducting material such as a sulfonated aromatic polymer or sulfonated fluoropolymer (e.g., Published Patent WO99/10165 and U.S. Pat. No. 7,052,793 B2). The Gore membrane is comprised of a Teflon® fluoropolymer film filled with an ion-conducting Nafion® solution (e.g., U.S. Pat. No. 5,635,041). Other composite membranes are comprised of a proton conducting polymer and an inorganic additive. Both microscale additives, e.g., heteropolyacids [Li, L. et al., Power Sources, 162, 541-546 (2006)], zirconium phosphate [Costamagna, P., et al., S. Electrochim. Acta, 47, 1023 (2002)], calcium phosphate [Park, Y. S. et al., Solid State Ionics, 176, 1079-1089 (2005)], and silica [Miyake, N. et al., J. Electrochem. Soc. 148, A905 (2001), Shao, Z-G. et al., J. Membrane Sci., 229, 43-51 (2004), Lin, C. W. et al., J. Membrane Sci., 254(1-2), 197-205 (2005), Antonucci, P. L. et al., Solid State Ionics, 125, 431 (1997), Adjemian, K. T. et al., J. Electrochem. Soc. 149, A256 (2002)], and nanoscale additives, e.g., titanium dioxide nanoparticles [Prashantha, K. et al., J. Appl. Polym. Sci., 98, 1875-1878 (2005)], and nano-scale silica [Su, Y. H. et al., Power Sources, 155, 111-117 (2006), Chang, H. Y. et al., J. Membrane Sci. 218, 295-306 (2003), Wilson, B. C. et al., Macromolecules, 37, 9709-9714 (2004)] have been studied extensively. In all of these membranes, the addition of inorganic fillers generally improves mechanical, dimensional and thermal stability, and decreases methanol permeability in direct methanol fuel cells, but also results in decreased proton conductivity.

Two composite fuel cell membranes based on microscale additives carrying proton-conducting sulfonic acid groups have been reported. Sulfonic acid functionalized silica [Kim, D. et al., Electrochem. Commun., 6, 1069-1074 (2004)] prepared by reaction with bis[3-(triethoxysilyl)-propyl]tetrasulfane and oxidation with hydrogen peroxide was formulated into both sulfonated and non-sulfonated hydrogenated polybutadiene-styrene block copolymers [Acosta, J. L. et al., J. Appl. Polym. Sci. 90, 2715-2720 (2003)] and zeolites carrying sulfonated phenylethyl groups were formulated into Nafion® [Holmberg, B. A. et al., Polym. Prepr. 45(1), 24-25 (2004)].

Four composite fuel cell membranes based on silsesquioxanes have been reported; namely: (1) Polymethylmethacrylate or polystyrene copolymers with pendant POSS groups and proton-conducting polymers have been blended (see US Pub. Patent Appln. 20070190385 A1); (2) silsesquioxane resins have been added to sulfonated polyetheretherketone S-PEEK [Karthikeyan, C. S. et al., Macromol. Chem. Phys. 207(3), 336-341 (2006)]; (3) 10 nm to 10 μm VTMOS polysilsesquioxane spheres [Kim, Y. B. et al., Macromol. Rapid Commun. 27(15), 1247-1253 (2006)] have been added to sulfonated polyethersulfone (S-PES)-S-PEEK blends (Cheon, H. S. et al., Memburein 15(1), 1-7 (2005)]; and (4) a proton-conducting sulfonated bridged silsesquioxane membrane [Khiterer, M. et al., Chem. Mater. 18, 3665-3673 (2006)] was prepared by making a disulfide-functionalized xerogel membrane, and post-oxidizing the disulfide groups to sulfonic acid groups in nitric acid. A conductivity of 0.0062 Scm⁻¹ was measured at ambient temperature and 100% RH. Only one other composite fuel cell membrane based on a sulfonated polyhedral silsesquioxane (POSS) has been reported [Chang, Y-W. et al., Polym. Adv. Technol. 18(7), 535-543 (2007)]. An open-cage POSS carrying three glycidyl epoxy groups was reacted with 4-hydroxybenzenesulfonic acid, the resulting sulfonated POSS was blended with polyvinylalcohol and the blend was cross-linked using ethylenediaminetetracetic dianhydride (EDTAD). This system has several disadvantages: it requires a multi-step fabrication process and it contains chemically unstable methylene groups. Additionally, the mechanical and chemical stability was not reported.

The hurdles to overcome for polymeric membranes are: increased continuous use temperatures, high proton conductivity at low water content (e.g., 120° C. and 50% relative humidity as set by the United States Department of Energy), and long-term durability under use conditions. Current sulfonic acid-based materials suffer from low conductivity in the absence of water. [See for example, J. E. McGrath et al., Chem. Rev. 104, 4587-4612 (2004)].

Given the drawbacks of conventional sulfonated linear polymer PEMs, there is an ongoing need for a PEM in combination with an anode layer and a cathode layer forming a membrane electrode assembly (MEA) where the PEM has nano-particles carrying proton conducting groups in higher density per unit volume than that seen in the prior art.

### BRIEF SUMMARY OF THE INVENTION

This invention relates to the preparation of an improved PEM for fuel cell applications such that the membrane is more robust than prior art membranes with comparable proton conductivity. Specifically, this invention provides a PEM (for MEA systems) that has nano-particles that carry proton conducting groups in higher density than available from the known art.

This invention also relates to a sulfonated membrane polymer where the total sulfonate concentration is the sum of the sulfonate groups attached to the membrane polymer plus the sulfonate concentration from the nanoparticles. This combination will produce a membrane with less susceptibility to swelling at high humidity and therefore increased lifetime.

This invention provides a composition of matter for a high proton conductance, solid polymer electrolyte membrane, said membrane comprising:
A) a nano-additive carrying proton conducting groups having a size from about 1 nm to about 1,000 nm;
B) a carrier polymer for the nano-additive of Part A; and
C) a proton exchange membrane (PEM) or membrane electrode assembly (MEA) formed by mixing the components of Part A and Part B above.
   These nano-additive membranes are useful in fuel cells and batteries.

### BRIEF DESCRIPTION OF THE DRAWINGS

FIG. 1 is a diagram of a hydrogen fuel cell. These cells operate on the following equations:

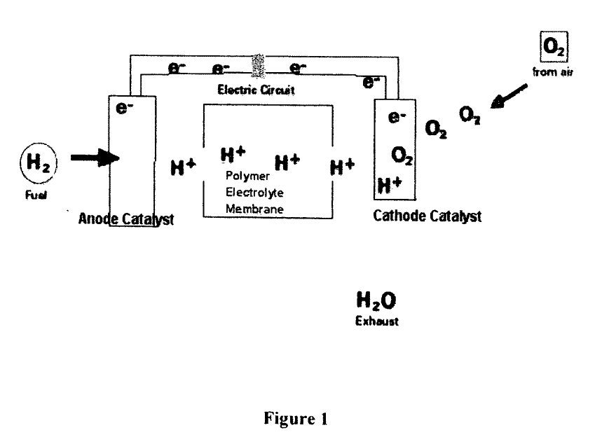

2H₂→4H⁺+4e

O₂+4e⁻+4H⁺→2H₂O

FIG. 2 illustrates the relationship between a proton exchange membrane (PEM) and a membrane electrode assembly (MEA).

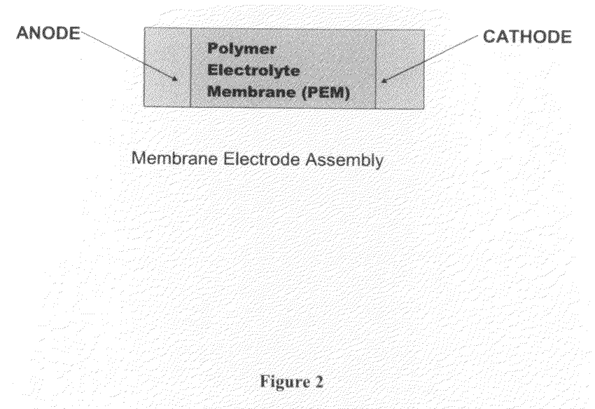

FIG. 3 shows the structure of and process to make the POSS-based nano-additive used in this invention (where Ar=PhSO₃H).

FIG. 4 shows the structure of and process to make the phosphazene-based nano-additive used in this invention.

FIG. 5 shows the structure of DuPont's Nafion polymer.

FIG. 6 shows the structure of imidazole.

FIG. 7 illustrates the process of sulfonation of Solvay® Radel A and Solvay® Radel R class of polymers.

### DETAILED DESCRIPTION OF THE INVENTION

### Glossary

The following terms as used in this application are to be defined as stated below and for these terms, the singular includes the plural.
EDTAD means ethylenediaminetetracetic dianhydride
EIS means electrochemical impedance spectroscopy
FCT means Fuel Cell Technologies Dual Channel Fuel Cell Test Station (Albuquerque, N. Mex.)
hr(s) means hour(s)
MEA means membrane electrode assemblies
PBI means polybenzimidazole
PECVD means plasma enhanced chemical vapor deposition
PEEK means polyetheretherketone
PEM means proton exchange membrane or proton conducting membrane
PES means polyethersulfone
POSS means polyhedral oligosilsesquioxanes
PSU means polysulfone
RH means relative humidity
RT means room temperature, about 20 to about 25° C.
THF means tetrahydrofuran
VTMOS means vinyltrimethoxysilane

### Discussion

In this invention, the use of nano-forms of silica functionalized with proton-conducting groups, and of other nano-additives functionalized with proton-conducting groups, is intended. In this invention, some proton-conducting capacity is provided by the nano-additive, in addition to the polymer, that should have the benefits of the polymer-silica approach discussed above. In addition, a higher density of proton-conducting functional groups is imparted by the nano-scale nature of the functionalized nano-additive (in contrast to the micro-scale nature of the conventional non-functionalized silica additives), resulting in a further improvement of proton conductivity in combination with maximum dimensional stability. This invention concerns the concept of improving the physical robustness of composite fuel cell membrane performance without compromising proton conductivity by using a closed-cage T8 polyhedral oligosilsesquioxane (POSS) form of nano-silica functionalized with proton-conducting groups, or other nano-additive functionalized with proton-conducting groups.

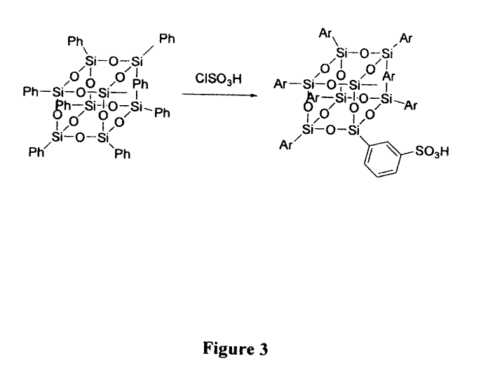

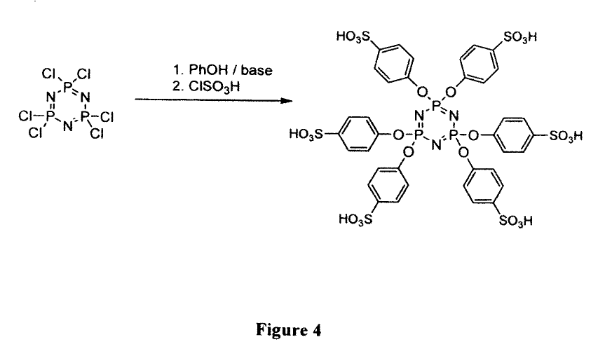

The present invention uses nano-additives carrying proton conducting groups formulated into a carrier polymer to fabricate a PEM. The present invention increases the dimensional stability of a PEM relative to its conductivity using POSS-based nano-additives (see FIG. 3) or cyclic phosphazene-based nano-additives (see FIG. 4) or small molecules carrying sulfonic acid groups.

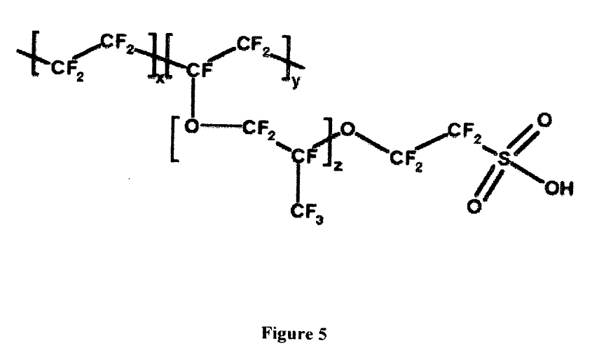

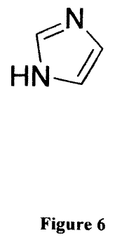

The conventional approach to PEM polymers is to place proton-conducting groups onto aromatic or perfluorinated polymers [see J. E. McGrath et al., Chem. Rev., 104, 4587-4612 (2004)]. The most common proton-conducting groups are sulfonic acid (SO₃H), phosphonic acid (PO₃H), imidazole (FIG. 6) and sulfonimide (SO₂NHSO₂). Polymers are aromatic and/or perfluorinated for chemical stability to the acidic conditions and to the oxidizing conditions (peroxides at cathode) that exist in fuel cells. The standard against which all other PEM polymers are measured is Dupont's Nafion (FIG. 5).

Various polyphosphazene membranes have been used in fuel cells with varying degrees of success [U.S. Pat. No. 6,365,294; M. V. Fedkin, et al., Materials Letters 52, 192-196 (2002); Harry R. Allcock et al., Macromolecules 34, 6915-6921 (2001); Hao Tang et al., J. Appl. Polym. Sci. 79, 49-59 (2001); Q. Guo et al., J. of Membrane Sci. 154, 175-181 (1999); R. Wycisk et al., J. of Membrane Sci. 119, 155-160 (1996)]. These systems have the disadvantages of low glass transition temperature and poor mechanical properties. Additionally, these systems must undergo an additional cross-linking process to overcome these disadvantages. In contrast, this invention uses small molecule (non-polymeric) phosphazene nano-additives in PEMs which has not been tried by these prior systems.

The composite fuel cell system by Chang, discussed above, differs considerably from the system described in this application, for example, open-cage versus closed-cage POSS, cross-linked versus non-cross-linked structure, and aliphatic versus aromatic composition. In Chang's system, the open cage POSS entity does not function as a nano-additive but as a co-monomer in a three-dimensional cross-linked structure. Chang's system also has the disadvantages of poor chemical stability (owing to aliphatic content), complex fabrication process and no measurable improvement in mechanical properties.

One embodiment of this invention is reduction of swelling and improved dimensional stability in the presence of water. Conventional PEM polymers in fuel cells fail at high humidity, and when subjected to humidity cycling, due to excessive swelling.

This invention requires the presence of a carrier polymer and a nano-additive to obtain the improved PEM for MEAS. The nano-additive must interact with the carrier polymer such that a structure capable of conducting protons is created. In a sulfonated carrier polymer, the nano-additives have a similar solubility parameter to the carrier polymer. The nano-additives could be said to be evenly dispersed and/or dissolved in the carrier polymer. In a carrier polymer with non-sulfonated (non-proton conducting content), the nano-additives must be in close proximity in channels (or in some other non-homogeneous morphology), such that proton conducting paths exist through the material. One way of enhancing the channel structure of this type is by electrostatic orientation of PEM formulations during solution casting in the presence of an electric field.

The nano-additives carry proton conducting groups where carrying may be defined as covalently bonded or attached by other means to the nano-additive structure, e.g., POSS. The size of the nano-additive domain in the fuel cell membrane may range from about 1 nm (e.g., the size of an individual POSS molecule) to about 1,000 nm (if nano-additive molecules are aggregated to any extent within the membrane); also preferred is a size of up to about 100 nm.

Some of the nano-additive particles for this invention are sulfonated polyhedral oligosilsesquioxanes (POSS). POSS are stoichiometrically well-defined cage compounds prepared by the hydrolysis and condensation of trifunctional silanes of the form RSiX₃ [see for example, D. Scott, J. Am. Chem. Soc. 68, 356 (1946); M. G. Voronkov; V. I. Lavrent'yev, Topics Curr. Chem. 102, 199-236 (1982)]. The condensation reactions used to make these products can generate products ranging from small molecules, oligomers, and clusters to resins of highly complex structure. The products obtained are highly dependent upon silane and water concentration, pH, temperature, solubility and catalyst [e.g., C. J. Brinker; G. W. Scherer, Sol-Gel Science: The Physics and Chemistry of Sol-Gel Processing, Academic Press, San Diego, 1990]. The nanoscopic polyhedral oligosilsesquioxanes used in this invention are fully condensed compounds of the form R₈Si₈O₁₂ with a distance of 1.5 nm between R groups on adjacent corners of the POSS cage (see FIG. 3). They are of a precisely defined size, commercially available (from Hybrid Plastics, Inc., Fountain Valley, Calif.; now in Hattiesburg, Miss.) with a variety of functional groups, and have been used in an extremely wide range of syntheses and applications in the last few years [Feher, F. J., et al., Polyhedron, 14, 3239-3253 (1995); and Lichtenhahn, J. D. in Polymeric Materials Encyclopedia, Salamone, J. C., Ed., CRC Press: New York, 1996, Vol. 10, pp. 7768-7778].

The present improved PEM used in MEAs provides higher temperature performance, mechanical reinforcement, lower gas permeability, and reduced swelling relative to its conductivity (density of proton conducting groups).

A composition comprised of fewer proton-conducting groups on the backbone with the total proton-conducting concentration of groups being made up of nano particulate additives shows better dimensional stability than putting all the proton-conducting groups on the polymer backbone.

The invention will be further clarified by a consideration of the following examples, which are intended to be purely exemplary of the present invention.

### Example 1

### Preparation of POSS-Based Nano-Additive (FIG. 3)

Octaphenyl-POSS (69.8 g, 67.50 mmol) was added to chlorosulfonic acid (250 mL, 3.76 mol). The reaction solution was stirred overnight at RT. Unreacted chlorosulfonic acid was removed by vacuum distillation. Deionized water (400 mL) was added to dissolve the crude product. The volume was reduced to 100 mL under reduced pressure. The crude product was washed three times with anhydrous THF (1.5 L). The product was then dried under reduced pressure to give a brown solid in quantitative yield. The product has the following spectra:

IR: ν (cm⁻¹): 3070 (OH of SO₃H), 2330 (SO₃H—H₂O), 1718, 1590, 1470, 1446, 1395, 1298, 1132 (SO₃ asym), 1081 (SO₃ sym), 1023 (SiOSi asym), 991, 806 (SiOSi sym);

¹H NMR (D₂O): δ (ppm) 7.54 (dd; ArH meta to POSS), 7.81-7.83 (2dd; ArH para to SO₃H, ArH para to POSS), 8.03 (dd; ArH ortho to SO₃H and POSS);

¹³C NMR (D₂O): δ (ppm) 122.5 (ArCH), 128.4 (ArCH), 130.0 (ArCH), 143.2 (ArCH); and

MALDI-TOF MS: m/z 1698 (Calc. 1674, molecular ion plus Na).

### Example 2

### Preparation of Phosphazene-Based Nano-Additive (FIG. 4)

### A. Preparation of Phosphazene Nano-Additive Precursor.

Sodium hydride (25.8 g, 1.07 mol) was mixed under dry nitrogen with THF (250 mL, 3.1 mol) and cooled in an ice/water bath. Phenol (100.0 g, 1.06 mol) in solution with THF (250 mL, 3.1 mol) was slowly added to the stirring mixture. Once the addition was complete, a solution of hexachlorocyclotriphosphazene (61.5 g, 0.177 mol) in THF (250 mL, 3.1 mol) was added slowly. The mixture was brought to reflux and heated overnight. A white precipitate was removed by reduced pressure filtration. The precipitate was washed with dry THF. The filtrate was collected and then dried under reduced pressure. The resulting white crystalline solid was redissolved in acetone (200 mL, 2.72 mol), which formed a suspension that subsequently precipitated in deionized water (1500 mL, 83 mol). The resulting white crystalline precipitate was filtered off under reduced pressure. The product was then recrystallized in hexane-toluene (1.5:1 v/v, 250 mL). The resulting needle crystals were dried [yield=83 g (68%)]. The product has the following spectra:

¹H NMR (D₂O): δ (ppm) 6.91-7.17 (m; ArH);

¹³C NMR (D₂O): δ (ppm) 121.0 (ArCH), 124.8 (ArCH), 129.4 (Ar—CH), 150.6 (ArCO); and

MS (LC): m/z 694 (Calc. 695, molecular ion).

### B. Sulfonation of Hexaphenoxycyclotriphosphazene Precursor.

Hexaphenoxycyclotriphosphazene (36.30 g, 5.23 mmol) was dissolved in dichloromethane (200 mL, 3.1 mol), cooled in an ice/water bath, and chlorosulfonic acid (70 mL, 1.05 mol) was added. The reaction was allowed to warm to RT overnight. The mixture was allowed to separate. The organic layer was collected and vacuum distilled to yield a red oil. Water (200 mL, 11.11 mol) and methanol (200 mL, 5 mol) were added to dissolve the oil. The resulting mixture was then filtered. The red solution was dried under reduced pressure to yield a red oil, 104 g. The product has the following spectra:

IR: ν(cm⁻¹) 2924 (OH of SO₃H), 1460, 1429, 1375 (asym SO₂), 1301, 1133, 1021, 1120 (sym SO₂);

¹H NMR (D₂O): δ (ppm) 7.13-7.16 (d; ArCH meta to SO₃H), 7.62-7.64 (d; ArCH ortho to SO₃H);

¹³C NMR (D₂O): δ (ppm) 120.5 (ArCH), 127.5 (ArCH), 138.6 (ArCO), 153.7 (ArCSO₃H); and

MS (EI positive mode): m/z 1305 (Calc. 1305, sodium salt).

### Example 3

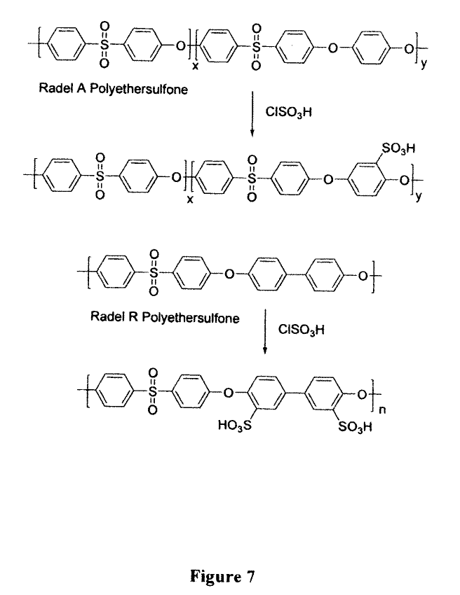

Formulations of sulfonated Solvay® Radel R5000 (prepared as described in U.S. Pat. No. 6,790,931) as carrier polymer (FIG. 7) and sulfonated POSS or sulfonated phosphazene as nano-additive (Examples 1 and 2), were each cast into films by preparing a 20 wt. % solids solution of carrier polymer and nano-additive in 1-methylpyrrolidone (NMP), and casting a film by drawing a blade over the solution.

### Example 4

The following table demonstrates that PEMs based on the POSS-containing Example 3 films above have comparable proton conductivity to Nafion combined with superior dimensional stability and mechanical strength. When compared with 100% sulfonated Solvay Radel R5000 S-PPSU control membranes, the POSS containing membranes exhibit superior conductivity, comparable dimensional stability and slightly decreased mechanical strength.

Through-plane conductivities of the membranes were measured at 70° C. and 80% RH by EIS using FCT fitted with a single cell AC-Z impedance unit.

In-plane conductivity measurements of the cast membranes were obtained using an Agilent Milliohmmeter type 4338B AC impedance meter with a test frequency of 1 kHz. An open-frame cell with 2 platinized platinum electrodes was used. The membranes were first treated in a 1.0 M H₂SO₄ solution for several hrs at RT and then subsequently washed with deionized water for several additional hrs. The conductivity of the membranes was measured in the lateral (in-plane) direction while still in the fully hydrated state. The tensile strength properties of the cast membranes were determined using a ChemInstruments TT-1000 tensile tester equipped with a 25 pound load cell.

L_{C} was measured after exposing a film to 100% RH environment for 24 hrs according to ASTM test D1042. In this method, changes to an arc inscribed on a film are studied by optical microscopy. Samples were equilibrated for 24 hrs in the laboratory at RT, inscribed with an arc, exposed to the test conditions, and then re-inscribed. The difference between the two arcs was measured with the aid of a microscope, and expansion (or contraction) of the film was quantified as a percent of linear change, L_{C}, where D_{B} is the distance between the scribed arcs, and D_{I} is the initial scribed distance. Large positive values of L_{C} are undesirable, and indicate significant membrane swelling and dimensional instability.

L_{C}=D_{B}/D_{I}×100

Table 1 shows these results.

TABLE 1

| | Conductivity | | Dimensional |
|---|---|---|---|
| | (Scm⁻¹) | Tensile | Stability |
| | Through- | Strength | (L_{c}) |
| | plane/70° C. | (N mm⁻²) | 80° C. |
| | In-plane/RT | Elongation | 52% RH |
| Membrane | In-plane/80° C. | (%) | 100% RH |
| Nafion ® 212 | 0.100 | 25 | −1.20 |
| 7.6 wt. % SO₃H | 0.100 | 282 | +2.3 |
| | 0.100 | | +10.4 |
| 100% S-PPSU | 0.065 | 33 | −2.27 |
| (IEC = 1.67) | 0.049 | 27 | +0.83 |
| | 0.080 | | 0.0 |
| 80% S-PPSU | 0.083 | 23 | −3.08 |
| (IEC = 1.67) | 0.054 | 36 | +0.58 |
| 20% S-POSS | 0.073 | | +1.37 |
| 100% S-PPSU | 0.038 | 45 | −1.90 |
| (IEC = 1.55) | 0.058 | 32 | — |
| | — | | +2.70 |
| 90% S-PPSU | 0.068 | 39 | −2.20 |
| (IEC = 1.55) | — | 9 | — |
| 10% S-POSS | — | | +1.35 |
| 80% S-PPSU | 0.066 | 25 | −3.75 |
| (IEC = 1.55) | — | 4 | — |
| 20% S-POSS | — | | 0.0 |

These results show that the PEMs have comparable conductivity to Nafion but have superior dimensional stability and reduced swelling.

### Example 5

The following table demonstrates that PEMs based on the POSS-containing Example 3 films above have superior storage modulus to Nafion at various temperatures. When compared with 100% sulfonated Solvay Radel R5000 S-PPSU control membranes, the POSS containing membranes have slightly lower modulus from 30 to 120° C., and significantly lower modulus at 170° C. DMA measurements were made using a TA Instruments Model 2980 Dynamical Mechanical Analyzer with film tension fixture.

The results are shown in Table 2 below.

TABLE 2

| | Storage | Storage | Storage |
|---|---|---|---|
| | modulus | modulus | modulus |
| | at 30° C. | at 120° C. | at 170° C. |
| Membrane | (MPa) | (MPa) | (MPa) |
| Nafion ® 117 | 600 | 50 | 3.3 |
| S-PPSU (IEC = 1.55) | 1954 | 1750 | 884 |
| 80% S-PPSU (IEC = 1.55) | 1426 | 1120 | 23 |
| 20% S-POSS | | | |

These results demonstrate that PEMs based on the POSS-containing Example 3 films have superior storage modulus to Nafion at various temperatures.

Although the invention has been described with reference to its preferred embodiments, those of ordinary skill in the art may, upon reading and understanding this disclosure, appreciate changes and modifications which may be made which do not depart from the scope and spirit of the invention as described above or claimed hereafter.

What is claimed is:

1. A composition of matter for a high proton conductance, solid polymer electrolyte membrane, said membrane comprising:
A) a nano-additive carrying proton conducting groups having a size from about 1 nm to about 1,000 nm;
B) a carrier polymer for the nano-additive of Part A; and
C) a proton exchange membrane (PEM) or membrane electrode assembly (MEA) formed by mixing the components of Part A and Part B above.

2. The composition of claim 1 wherein the proton conducting groups are contributed by polyhedral oligosilsesquioxanes (POSS)-based nano-additives or cyclic phosphazene-based nano-additives or small molecules carrying sulfonic acid groups.

3. The composition of claim 1 or 2 wherein the carrier polymer is sulfonated.

4. The composition of claim 3 wherein the total sulfonate concentration is the sum of the sulfonate groups attached to the membrane polymer plus the sulfonate concentration from the nanoparticles.

5. The composition of claim 4 wherein the membrane has less susceptibility to swelling at high humidity and increased lifetime compared to sulfonated membranes.

6. The composition of claim 2 wherein the nano-additive has a similar solubility parameter to the carrier polymer.

7. The composition of claim 1 or 2 wherein the nano-additives are approximately evenly dispersed and/or dissolved in the carrier polymer.

8. The composition of claim 1 or 2 wherein the nano-additives are in close proximity in channels such that proton conducting paths exist through the material.

9. The composition of claim 8 wherein the channels are formed by electrostatic orientation of PEM formulations during solution casting in the presence of an electric field.

10. A fuel cell comprising the composition of claim 1 or 2.

11. A battery comprising an anode side, a cathode side, and a polymer electrolyte separating the anode side from the cathode side, wherein the polymer electrolyte includes the composition of claim 1 or 2.
